(19) United States
(12) Patent Application Publication
(10) Pub. No.: US 2015/0021869 A1
(43) Pub. Date: Jan. 22, 2015

(54) KNEE SCOOTER

(71) Applicant: Hal Clayton Morgan, Jr., Spruce Pine, NC (US)

(72) Inventor: Hal Clayton Morgan, Jr., Spruce Pine, NC (US)

(21) Appl. No.: 14/336,081

(22) Filed: Jul. 21, 2014

Related U.S. Application Data
(60) Provisional application No. 61/856,785, filed on Jul. 22, 2013.

(51) Int. Cl. A47C 16/04; B25H 5/00

(52) U.S. Cl. CPC A47C 16/04; B25H 5/00
USPC 280/32.5

(57) ABSTRACT

A knee scooter apparatus includes first and second concave cradle sections for receiving and supporting the knees of a user. An adjustable length cross member can be attached to the first and second cradle sections. The cradle sections can be supported on a floor surface by a plurality of wheels rotatably mounted on the underside of the cradle sections.

### CROSS REFERENCE TO RELATED APPLICATIONS

This application claims benefit to U.S. Provisional Patent Application No. 61/856,785, filed Jul. 22, 2013, which is incorporated herein.

### TECHNICAL FIELD AND BACKGROUND OF THE INVENTION

The present invention relates to the field of rolling devices that are useful to individuals who work with their hands on floors or other surfaces that require kneeling or positioning the worker on their hands and knees in order to accomplish a task. One embodiment of the present invention comprises an apparatus that provides support for a person working on his hands and knees and facilitates movement close to the floor.

Numerous tasks and jobs require an individual to kneel on their knees and get close to a floor surface in order to accomplish a particular task. For example, painters, welders, shelf stockers, child care providers, cleaners, custodial workers, floor installers, floor sanders, floor finishers, parking lot maintenance providers, and other workers often have tasks that require them to get on their hands and knees on the floor and move around to different areas on the floor. Various protective devices, such as knee pads, have been used by such workers to protect their legs, calves, and especially their knees. There is a need for these individuals to have a device that not only protects their knees or other lower extremities but also adds efficiencies to the process of working in a kneeling position or in a position that requires the user to position themselves on hands and knees and move around on the floor.

### SUMMARY OF INVENTION

Therefore, one objective of the invention is to provide an apparatus that provides support to a person working on his hands and knees on a floor surface. Another object of the invention is to provide an apparatus that facilitates a person's movement on the floor when in the kneeling position. These and other objects of the invention can be achieved in the preferred embodiment of the invention disclosed below.

One embodiment of the invention comprises a knee scooter apparatus comprising two cradle sections having upper and lower surfaces, a cross member connecting the two cradle sections, and a plurality of wheels connected to the lower surface of the cradle sections for facilitating movement of the apparatus on a floor surface. The upper surface of each cradle section is contoured for receiving a knee of a user.

According to another embodiment of the invention, the upper surface of each cradle section is concave.

According to another embodiment of the invention, there is padding on the upper surface of each cradle section for the comfort of the user.

According to another embodiment of the invention, the lower surface of each cradle section sits approximately one-fourth inch to one-half inch above the floor surface.

According to another embodiment of the invention, the length of the cross member is adjustable.

According to another embodiment of the invention, the cross member comprises first and second telescoping sections. Each telescoping section has a plurality of linearly arranged apertures formed therethrough. The apertures formed in the first section can be aligned with the apertures formed in the second section. A locking pin can be positioned through the aligned apertures of the first and second telescoping section to lock the cross member at a desired length.

According to another embodiment of the invention, the first and second telescoping sections are two substantially rectangular aluminum tubes.

According to another embodiment of the invention, four non-marring rubber ball bearing wheels are rotatably mounted to the lower surface of each cradle section.

According to another embodiment of the invention, each wheel is mounted to the lower surface of one of the cradle sections by a swivel caster.

### BRIEF DESCRIPTION OF THE DRAWINGS

FIG. 1 is a perspective view of a knee scooter according to a preferred embodiment of the invention;

FIG. 2 is another perspective view of the knee scooter of FIG. 1;

FIG. 3 is a front elevation of the knee scooter of FIG. 1;

FIG. 4 is a side elevation of the knee scooter of FIG. 1;

FIG. 5 is a partially exploded perspective view of the knee scooter of FIG. 1;

FIG. 6 is a front elevation of the knee scooter of FIG. 1;

FIG. 7 is another front elevation of the knee scooter of FIG. 1; and

FIG. 8 is another front elevation of the knee scooter of FIG. 1.

### DESCRIPTION OF PREFERRED EMBODIMENTS OF THE INVENTION AND BEST MODE

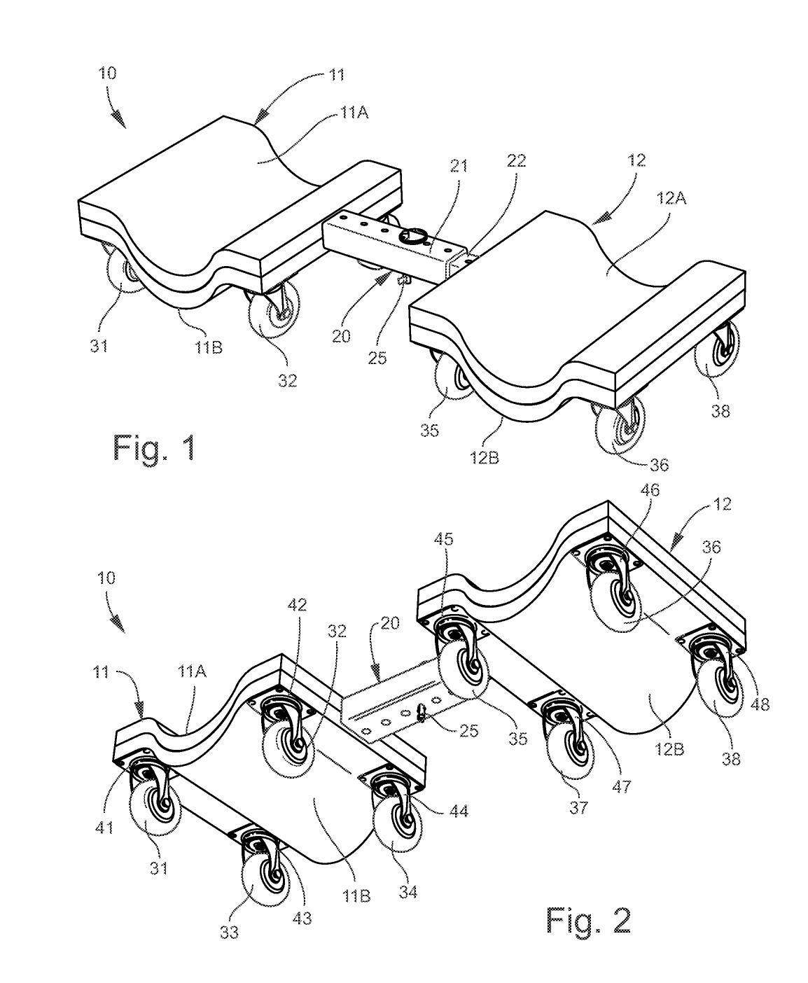

A knee scooter apparatus according to a preferred embodiment of the invention is illustrated in FIGS. 1-8, and shown generally at reference numeral 10. As shown in FIGS. 1 and 2, the apparatus 10 comprises a pair of knee cradles 11, 12 that are joined by an adjustable cross member 20, and a plurality of wheels 31-38 positioned on the underside of the knee cradles 11, 12.

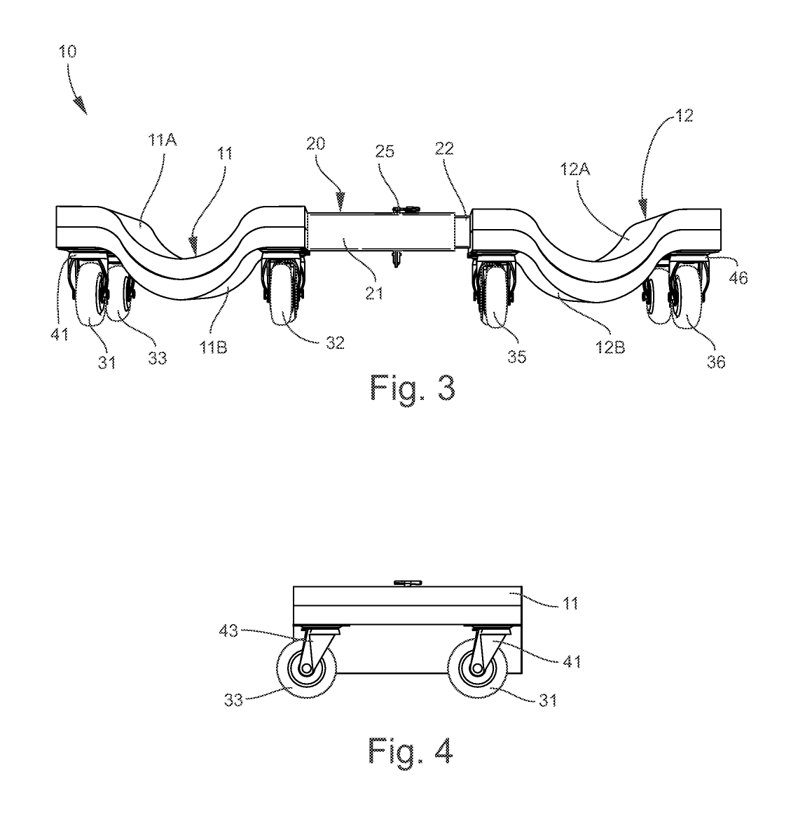

The knee cradles 11, 12 are contoured to provide a comfortable area for the user to position his knees, as shown in FIGS. 1 and 3. The upper surface 11A, 12A of each knee cradle 11, 12 is concave, as shown in FIGS. 1 and 3. When the apparatus 10 sits with the wheels 31-38 on a floor surface 50, as shown in FIG. 8, the lowest point of the lower surfaces 11A, 12B of the knee cradles 11, 12 are preferably a distance X of about one-fourth inch to one-half inch above the floor surface 50.

The knee cradles 11, 12 lie in a plane horizontal to the floor surface 50 at a level that is sufficiently close to the floor surface 50 that the user's knees are not significantly elevated off the surface. Padding can be positioned on the upper surface 11A, 12A of each cradle 11, 12 for the comfort of the user.

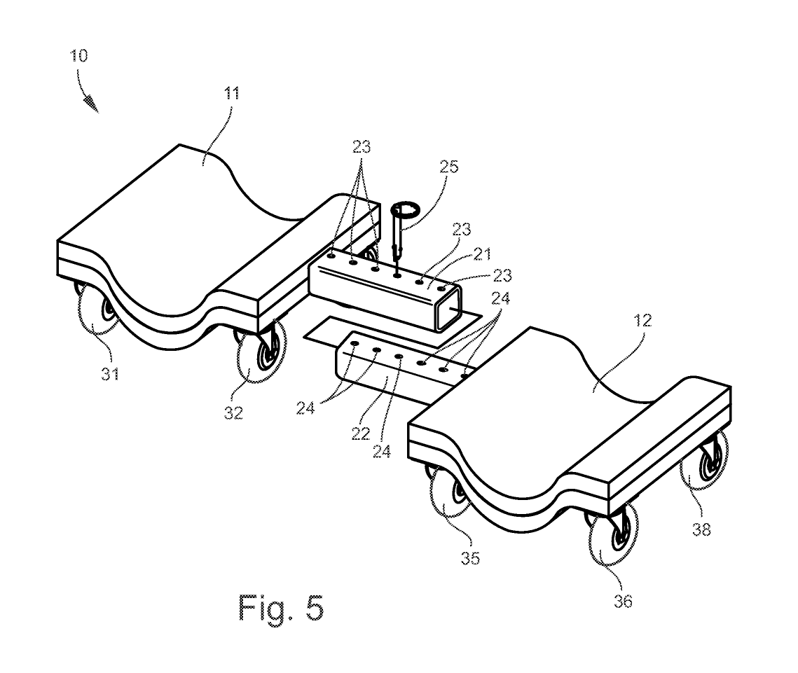

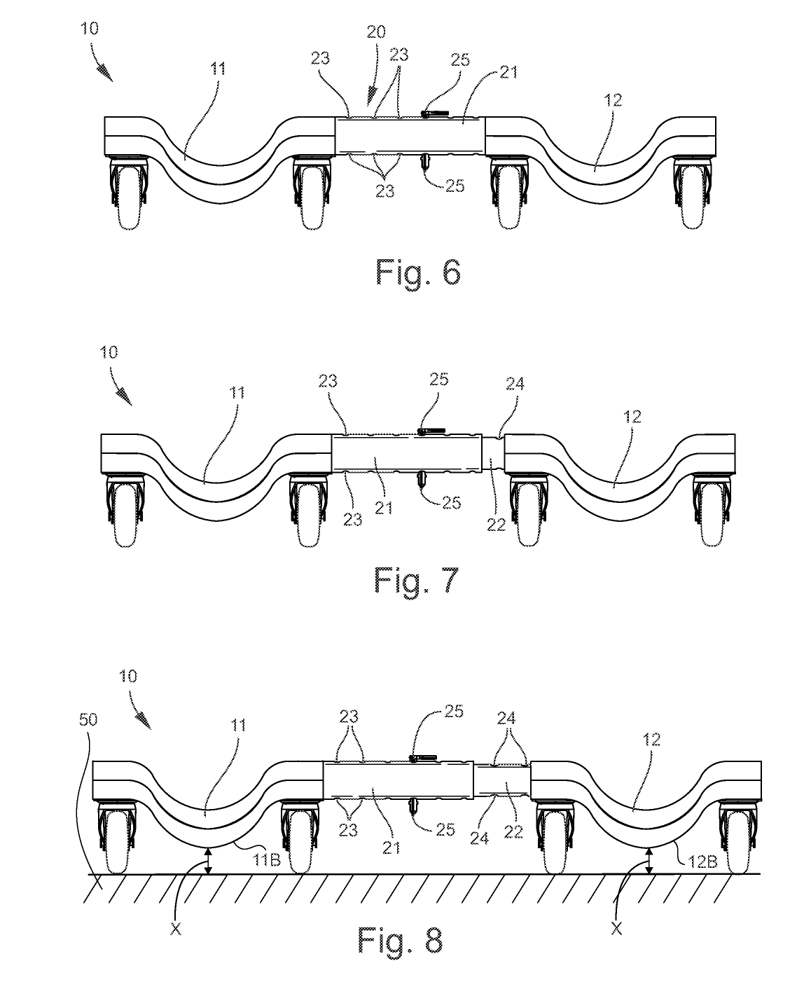

The cross member 20 can be comprised of two substantially tubular sections 21, 22, with one section 21 telescopically receiving the other section 22, as shown in FIG. 5. Preferably, the sections 21, 22 are rectangular and aluminum. A first plurality of linearly arranged apertures 23 are formed through one section 21, and a second plurality of similarly arranged apertures 24 are formed through the other section 22, as shown in FIG. 5. The apertures 23 formed in one section 21 can be aligned with the apertures 24 formed in the other section 22. The length of the cross member 20 can be adjusted by the user sliding the sections 21, 22 to align apertures 23, 24 from the cross member sections 21, 22 at various points, as shown in FIGS. 6-8, and inserting a locking pin 25 through the aligned apertures 23, 24 to attain the desired length of the cross member 20.

By adjusting the length of the cross member 20, the length of separation between the knee cradles 11, 12 can be adjusted. As such, the length of the cross member 20 can be to increase or decrease the amount of separation between the knee cradles 11, 12 to accommodate users of different size.

The knee cradles 11, 12 are supported by a plurality of wheels 31-38 mounted to the lower surfaces 11 B, 12B of the cradles 11, 12 that allow the user to roll across a floor surface 50. Preferably, there are four wheels 31, 32, 33, 34 mounted to one cradle 11, and four wheels 35, 36, 37, 38 mounted to the other cradle 12. As shown in FIGS. 1 and 2, the wheels 31-38 are positioned proximate the four corners of the cradles 11, 12, under the non-concaved areas of the cradles 11, 12. As such, the height of the cradles 11, 12 with respect to the floor is minimized and the apparatus 10 has a low profile.

Preferably, the wheels 31-38 are non-marring rubber ball bearing wheels that are rotatably mounted to the cradles 11, 12. The wheels 31-38 can be mounted to the lower surfaces 11 B, 12B by swivel casters 41-48. As such, the wheels 31-38 can swivel three hundred sixty degrees and allow speed of travel in any direction as determined by the user. The user can turn the direction of the knee scooter 10 by adjusting the position of the user's knees, legs, and feet.

The knee cradles 11, 12 lie in a plane horizontal to the floor surface 50 at a level that is sufficiently close to the floor surface that the user's knees are not significantly elevated off the surface. As such, when the user bends forward with hands on the floor 50, the difference in height between the palms of the user's hands and the user's knees is minimized for comfort in working on “all fours” with knees in the knee cradles 11, 12 and palms on the floor 50.

The user can place their knees for ease of mobility on the knee cradles 11, 12 while working with their hands on the floor 50 on which the apparatus 10 rests or while working upright in a kneeling position. The knee scooter 10 allows the user to position his or her knees on appropriate knee cradles 11, 12 and then bend toward a lower surface that supports the knee scooter 10 or to work in a kneeling position on top of the scooter 10 while working upright. The knee scooter 10 is designed for ease of moving across a floor surface while in a kneeling position.

A knee scooter apparatus and method of using same are described above. Various changes can be made to the invention without departing from its scope. The above description of the preferred embodiments and best mode of the invention are provided for the purpose of illustration only and not limitation—the invention being defined by the claims and equivalents thereof.

What is claimed is:

1. A knee scooter apparatus comprising:
(a) first and second cradle sections, each cradle section having upper and lower opposed surfaces, wherein the upper surface is contoured for receiving a knee of a user;
(b) a cross member connecting the first and second cradle sections; and
(c) a plurality of wheels connected to the lower surface of each cradle section for facilitating movement of the apparatus on a floor surface.

2. The apparatus according to claim 1, wherein the upper surface of each cradle section is concave.

3. The apparatus according to claim 2, wherein the lower surface of each cradle section sits approximately one-fourth inch to one-half inch above the floor surface.

4. The apparatus according to claim 1, wherein the length of the cross member is adjustable.

5. The apparatus according to claim 4, wherein the cross member comprises:
(a) first and second telescoping sections, each telescoping section having a plurality of linearly arranged apertures, wherein the plurality of apertures formed in the first section can be aligned with the plurality of apertures formed in the second section; and
(b) a locking pin for positioning through aligned apertures of the first and second telescoping section for locking the cross member at a desired length.

6. The apparatus according to claim 5, wherein the first and second telescoping sections comprise two substantially rectangular tubes.

7. The apparatus according to claim 6, wherein the two substantially rectangular tubes are comprised of aluminum.

8. The apparatus according to claim 1, wherein the plurality of wheels comprises four wheels rotatably mounted to the lower surface of each cradle section.

9. The apparatus according to claim 6, wherein the plurality of wheels comprises non-marring rubber ball bearing wheels.

10. The apparatus according to claim 8, further comprising a plurality of swivel casters, wherein each wheel is mounted to the lower surface of one of the cradle sections by one of the swivel casters.

11. A knee scooter apparatus comprising:
(a) first and second cradle sections, each cradle section having a concave upper surface for receiving a knee of a user;
(b) a cross member connecting the first and second cradle sections; and
(c) a first plurality of wheels connected to a lower surface of the first cradle section, and a second plurality of wheels connected to a lower surface of the second cradle section.

12. The apparatus according to claim 11, wherein the lower surface of each cradle section sits approximately one-fourth inch to one-half inch above the floor surface when the wheels are positioned on the floor surface.

13. The apparatus according to claim 11, wherein each cradle section includes padding positioned on the upper surface.

14. The apparatus according to claim 11, wherein the length of the cross member is adjustable.

15. The apparatus according to claim 14, wherein the cross member comprises:
(a) first and second telescoping sections, each telescoping section having a plurality of linearly arranged apertures, wherein the plurality of apertures formed in the first tube can be aligned with the plurality of apertures formed in the second tube; and
(b) a locking pin for positioning through aligned apertures of the first and second telescoping section for locking the cross member at a desired length.

16. The apparatus according to claim 15, wherein the first and second telescoping sections are substantially rectangular tubes, and are comprised of aluminum.

17. The apparatus according to claim 14, wherein the plurality of wheels comprises four wheels rotatably mounted to the lower surface of each cradle sections.

18. The apparatus according to claim 17, wherein the plurality of wheels comprises four non-marring rubber ball bearing wheels.

19. The apparatus according to claim 18, further comprising a plurality of swivel casters, wherein each wheel is mounted to the lower surface of one of the cradle sections by one of the swivel casters.

20. A knee scooter apparatus comprising:
(a) first and second cradle sections, each cradle section having a concave upper surface for receiving a knee of a user;
(b) an adjustable length cross member attached to the first cradle section and the second cradle section; and
(c) a first plurality of wheels rotatably mounted on a lower surface of the first cradle section, and a second plurality of wheels rotatably mounted on a lower surface of the second cradle section.
